(19) United States
(12) Patent Application Publication
(10) Pub. No.: US 2019/0209945 A1
(43) Pub. Date: Jul. 11, 2019

(54) COLUMN INTERNALS MOUNTING ANGLE

(71) Applicant: RVT Process Equipment GmbH, Steinwiesen (DE)

(72) Inventors: Stefan SCHLIMPER, Kronach (DE); Benjamin PECHTOLD, Gräfenthal (DE); Andreas GERTLOFF, Stockheim (DE)

(73) Assignee: RVT Process Equipment GmbH, Steinwiesen (DE)

(21) Appl. No.: 16/245,795

(22) Filed: Jan. 11, 2019

(30) Foreign Application Priority Data
Jan. 11, 2018 (DE) 102018100573.3

(51) Int. Cl. B01D 3/22; B01D 3/32

(52) U.S. Cl. CPC B01D 3/225; B01D 3/326

(57) ABSTRACT

An assembly kit for installation of two column trays in a column with an upper column tray can include at least one first downcomer with at least one downcomer wall, and with a lower column tray which is disposed vertically spaced beneath the upper column tray and connected thereto. The assembly kit can include at least one column internals mounting angle having at least one first mounting point, at least one second mounting point, and an adjustment device for adjusting a vertical distance between the at least one first mounting point and the at least one second mounting point, where the column internals mounting angle is attached with the at least one first mounting point to the downcomer wall and is connected with the at least one second mounting point to the lower column tray.

The present invention relates to an assembly kit for the installation of two column trays in a column with an upper column tray comprising at least one downcomer with at least one downcomer wall, and a lower column tray which is disposed vertically spaced beneath the upper column tray and connected thereto.

Furthermore, the present invention also relates to a column internals mounting angle for use in the assembly kit and a mass transfer column having at least one assembly kit mounted in the column interior.

Columns, in particular mass transfer columns, are used for rectification, absorption, desorption and heat transfer in the process industry, for example the chemical and petrochemical industry, in the refinery sector and in environmental technology. In the columns, two media, typically a gas and a liquid, are exposed to each other. The gas flows from bottom to top through the column, the liquid flows from the top to bottom through the column. In order to achieve high mass transfer performance in these devices, a large boundary surface between the phases must be realized. For this purpose, various basic types of contact elements have been established in industrial practice: column trays, such as sieve, valve or bubble cap trays, random packings and structured packings.

Column trays offer the advantage over structured packings and random packings that a large number of lateral extractors and inlets can be realized in a cost-efficient manner as required. In the event of fouling and incrustations, the use of column trays leads to systems with a long service life and low cleaning effort. The column trays are inserted horizontally into the column and serve to expose the gas and the liquid to each other. Each of the column trays comprises at least one downcomer via which the liquid flowing in the horizontal direction over the column tray is deflected downwardly in a vertical direction and directed onto the column tray therebeneath. On this column tray disposed therebeneath, the liquid again flows in the horizontal direction over the entire tray surface to the at least one further downcomer and there exits the column tray downwardly. Provided in each column tray are furthermore gas inlet openings through which the gas rises from bottom to top, i.e. in the vertical direction in the column. On the column trays, the so-called cross-flow trays, the gas and the liquid intersect and are thereby exposed to each other.

In order to obtain good separation performance, the column trays must be aligned in the columns as precisely as possible in the horizontal direction. As a result, the most uniform possible liquid distribution over the entire tray surface is achieved. Support rings on which the column trays rest along their circumference are typically attached, for example welded, to the column wall in the interior of the column. If these support rings are installed having too great a tolerance, then large deviations in the horizontal position of the column trays can arise and it is not possible to precisely align the column trays in the horizontal direction. In addition, it is known that the column trays can sag, especially with large column diameters. Also in this case, the column trays do not have a uniform horizontal level over their entire area. No uniform liquid distribution on the column tray is then possible and the separation efficiency of the column deteriorates.

It is already known to eliminate tolerance deviations by correction, for example, by attaching welded parts. It is further known to reinforce the column trays with additional supports to increase the stability of the column trays and to thus prevent sagging. Both measures, however, lead to increased assembly and material costs.

An assembly kit for the connection of two cross-flow trays with a support structure is already known from US 2013/0234348 A1. The assembly kit comprises a top cross flow tray with two lateral downcomers and a bottom cross flow tray with a central downcomer. The central downcomer comprises two downcomer walls which are connected to transverse braces mounted in an upper region of the downcomer. A strut extends upwardly starting out from each transverse brace. At the upper end of the struts, a cross member is arranged on which the upper cross flow tray is attached. The lower cross flow tray is attached to further cross members, which are attached to the outer sides of the downcomer walls of the central downcomer. In addition, further transverse braces can be arranged in the lower region of the downcomer, and be connected to the upper cross flow tray of a further assembly kit. The central downcomer is supported and the desired distance between the downcomer and the cross-flow tray disposed therebeneath is maintained with these further transverse braces. In this configuration, the central downcomers with the crossflow trays disposed thereabove therefore form a kind of tower which extends through the entire column or through all crossflow trays, respectively.

It is the object of the present invention to provide an assembly kit for the installation of at least two column trays in a column which avoids the drawbacks known from prior art and in particular allows easy and precise horizontal alignment and attachment of the column trays in the column interior.

For this purpose, the invention provides that the assembly kit comprises at least one column internals mounting angle which has at least one first mounting point, at least one second mounting point, and an adjustment means for adjusting a vertical distance between the at least one first mounting point and the at least one second mounting point, and which is attached with the at least one first mounting point to the downcomer wall of the downcomer of the upper column tray and is connected with the at least one lower mounting point to the second column tray.

This additionally creates a connection between the column trays and the downcomer wall. The downcomer wall is typically fixedly connected to the column. The connection of the lower column tray to the downcomer wall leads to the stabilization of the assembly kit, so that additional support beams for the column trays can be dispensed with. Of course, two assembly kits can be connected to each other, where the lower column tray of the upper assembly kit in this case represents the upper column tray for the first (i.e., the upper) column tray of the lower assembly kit. The position of the lower column tray is adjustable with the adjustment means, so that differences in height in the column tray can be compensated both during the initial assembly of the assembly kit in the column as well as in the installed state, for example, for repair measures. A sagging column tray can then be drawn upwardly and again moved to the horizontal position. Also, the compensation of different heights of the support ring is possible. For example, it can be provided that the vertical position of the at least one first and the at least one second mounting point is adjustable, so that a desired vertical distance between the at least one first and the at least one second mounting point can be adjusted. The column tray can thus be leveled horizontally.

In a further embodiment, it can be provided that a vertical position of the at least one first mounting point or the at least one second mounting point of the column internals mounting angle is defined and the at least one other mounting point of the column internals mounting angle is movable in the vertical direction. The at least one first or the at least one second mounting point is therefore fixedly arranged in the column internals mounting angle and only the vertical position of the at least one other mounting point is adjustable. The movable mounting point is therefore moved to the desired vertical position and fixed there. This allows for very simple adjustment of the vertical distance between the two mounting points.

It can be provided for this purpose, for example, that the adjustment means of the column internals mounting angle comprises at least one first element on which at least one second element is arranged movable in the vertical direction, and the at least one second element can be secured at different vertical positions. The first element is fixedly connected to the column internals mounting angle, the second element is connected to the lower column tray, moved to the desired position and fixed in this position so that the lower column tray is in the desired horizontal orientation.

Preferably, the adjustment means can comprise at least one vertically arranged bolt on which at least two nuts are arranged. This makes a very simple configuration possible. The bolt is passed through holes for mounting bolts provided on the lower column tray, and the desired horizontal position of the lower column tray is adjusted using the two nuts.

In yet another embodiment, it can be provided that also the horizontal position of the at least one first mounting point and/or the at least one second mounting point of the column internals mounting angle is adjustable. This makes it possible to attach the additional support through the column internals mounting angle in the horizontal direction at the required location of the respective column tray. For example, the mounting points can be formed as slots, in particular long holes, in the column internals mounting angle. To attach the column internals mounting angle to the column trays or the downcomer walls, respectively, bolts are inserted through the slots or long holes and inserted or screwed into openings provided in the column trays or the downcomer walls, respectively. Before being fixedly tightened, the column internals mounting angle can be moved in the horizontal direction until the desired position has been reached. The bolts are then completely tightened.

It can also be provided that the column internals mounting angle comprises several first and/or several second mounting points. As a result, the column internals mounting angle is respectively connected at several points to the upper column tray or the downcomer of the upper column tray, respectively and/or to the lower column tray. This leads to additional stability, which makes it possible to dispense with cross members as supports for the column trays. In this case, all first and second mounting points can be movable in the horizontal and/or the vertical direction.

According to yet another embodiment, it can be provided that the column internals mounting angle comprises a back and at least one leg connected to the back, where the at least one first mounting point is formed in the back and the at least one second mounting point is formed on the leg of the column internals mounting angle. Preferably, the back and the at least one leg of the column internals mounting angle are integrally formed, where the leg and the back enclose an angle. As a result, the column internals mounting angle is given higher stability. It can also be provided that the column internals mounting angle comprises two legs which are arranged parallel to each other and each enclose a right angle with the back. As a result, yet higher stability is obtained. The column internals mounting angle can be manufactured in a very simple manner, for example, as a sheet metal bending member. High stability is nevertheless present.

Furthermore, a recess for receiving a longitudinal strut can be formed in the back of the column internals mounting angle. In this case, a longitudinal strut is attached to the downcomer wall of the downcomer of the first column tray, onto which the column internals mounting angle is mounted and subsequently fixed at at least one first mounting point. This also leads to increased stability of the assembly kit.

In yet another embodiment, it can be provided that the at least one leg of the column internals mounting angle is connected to two spaced horizontal supports forming part of the at least one second mounting point. For this purpose, the column internals mounting angle preferably has two receptacles into which the horizontal supports are simply inserted. The horizontal supports can then further be firmly connected to the column internals mounting angle, for example, be welded thereto. A slot is then formed between the horizontal supports. At least one bolt on which the two nuts are arranged can be inserted into the slot. The lower column tray is located between the two nuts, so that the horizontal position of the second column tray is adjusted by adjusting the position of the nuts on the bolt. The supports with the slot formed therebetween and the bolt with the two nuts form at least one second mounting point.

It can preferably further be provided that the lower column tray is attached to the downcomer wall with a plurality of column internals mounting angles. This again additionally leads to increased stability of the assembly kit.

Preferably, it can further be provided that the at least one downcomer is arranged centrally in the upper column tray and comprises two downcomer walls, and that at least one column internals mounting angle is respectively arranged on each downcomer wall. The column trays are then configured to be multi-flow column trays, which entails advantages in terms of uniform liquid distribution and therefore good mass transfer, especially with large column diameters. The fact that the lower column tray is attached to two downcomer walls again increases the stability.

Yet further increase in stability can be obtained by arranging at least one cross strut in the interior of the at least one downcomer and each column internals mounting angle is attached as an extension of a cross strut to an outer side of the at least one downcomer wall.

In yet another embodiment, it can be provided that the column trays form a depressed inlet zone below the downcomer. This can be the case both with the upper column tray and the lower column tray. The depressed inlet zone is also referred to as an inlet cup. As a result, a material-efficient configuration of the column trays can be realized, which, however, is typically accompanied by a loss in stability. This loss in stability is compensated by the attachment of the respective lower column tray to the downcomer wall(s) of the downcomer of the respective upper column tray by way of the column internals mounting angles.

Furthermore, it can be provided that the at least one downcomer comprises mounting points at its ends facing the column for the attachment to the column. For example, holes can be provided in the downcomer wall(s) with which the downcomer is bolted to strips which are fixedly attached to the column in the interior of the column, for example, welded thereto. The downcomer then assumes a supporting and stabilizing function, the column trays are no longer attached only over their circumference to the column wall.

Furthermore, the invention also relates to a column internals mounting angle with at least one first mounting point for the attachment to an upper column tray, at least one second mounting point for the attachment to a lower column tray and an adjustment means for adjusting a vertical distance between the at least one first mounting point and the at least one second mounting point for use in an assembly kit according to one of the claims 1-14. This column internals mounting angle allows for a very simple attachment of the respective lower column tray to the downcomer of the respective upper column tray, whereby greater stability of the entire assembly kit is obtained. With the adjustment means for adjusting the vertical distance between the two mounting points, tolerance variations occurring during production can easily be compensated and the column tray can be leveled in the horizontal direction, so that a uniform liquid flow over the column tray is obtained.

In addition, the invention also relates to a mass transfer column having at least one assembly kit as described above attached in the column interior. Of course, several assembly kits can be mounted one above the other in the column. It is also possible to connect the assembly kits to each other in the manner already described by way of the column internals mounting angles and to thus increase stability. The lower column tray of the upper assembly kit then corresponds to the column tray referred to above as the “upper column tray”, and the upper column tray of the lower assembly kit corresponds to the column tray referred to above as the “lower column tray”. The upper column tray of the lower assembly kit is therefore attached to downcomer walls of the downcomer/s of the lower column tray of the upper assembly kit.

The invention shall be further illustrated below in more detail using the figures, where

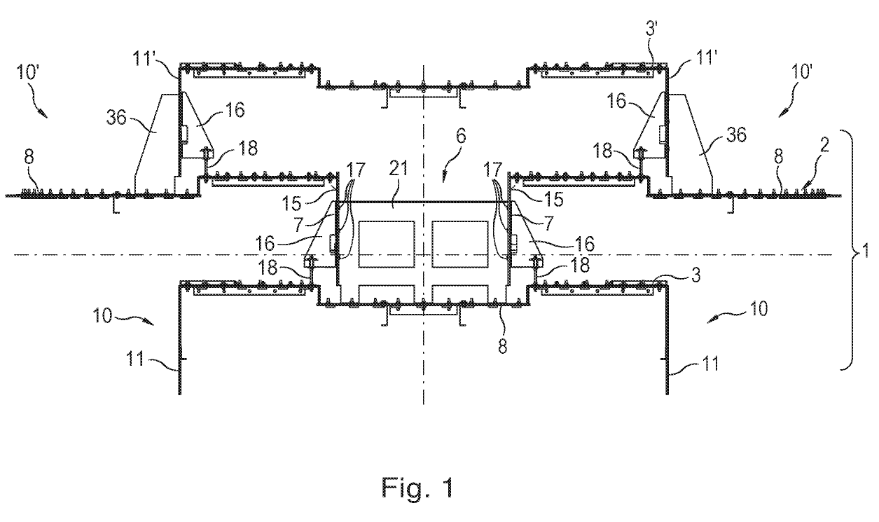

FIG. 1 shows a schematic representation of an assembly kit according to the invention,

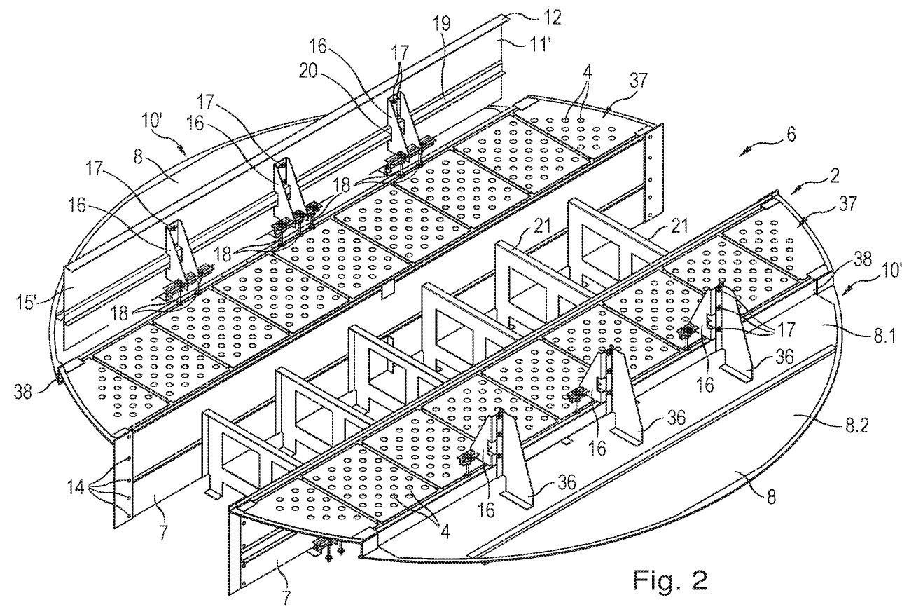

FIG. 2 shows a perspective view of a first column tray with a central downcomer from an assembly kit according to FIG. 1,

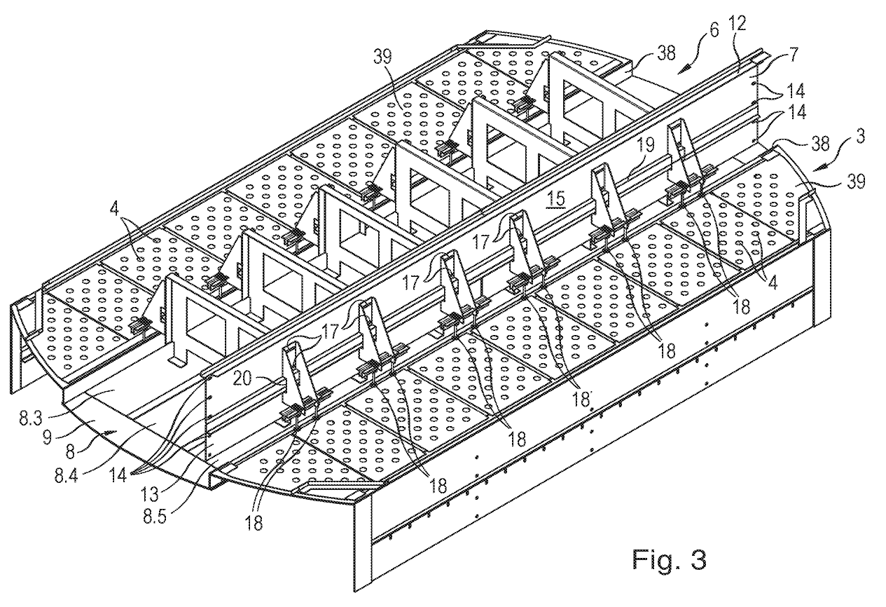

FIG. 3 shows a perspective view of a second column tray with two lateral downcomers from an assembly kit according to FIG. 1,

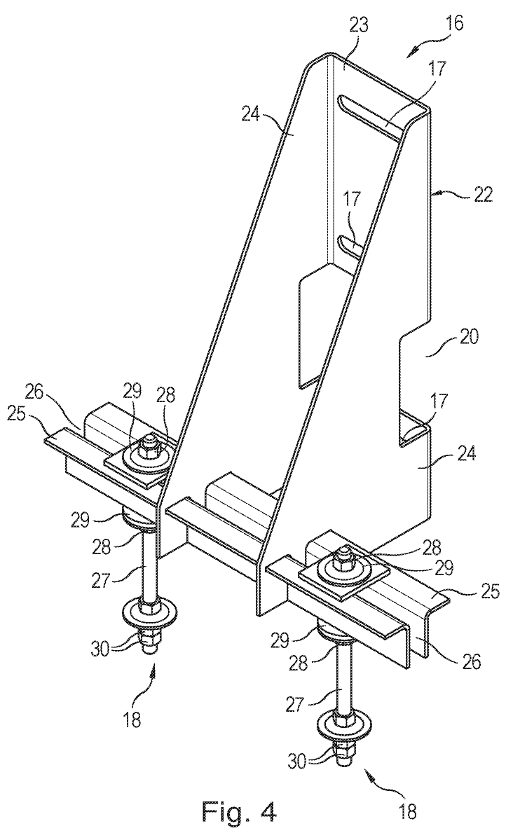

FIG. 4 shows a column internals mounting angle from an assembly kit according to FIG. 1,

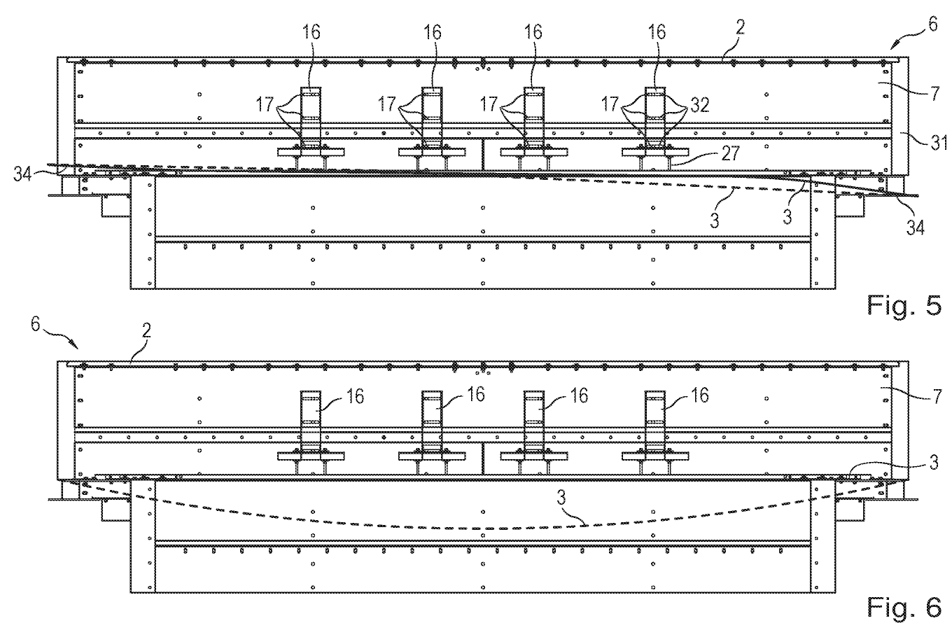

FIG. 5 shows a side view of a complete assembly kit according to FIG. 1 in the installed state for correcting of a crooked support ring, and

FIG. 6 shows a side view of a complete assembly kit according to FIG. 1 in the installed state for correcting of a sagging column tray.

FIG. 1 shows an assembly kit 1 for the installation of an upper column tray 2 and a lower column tray 3 into a column. In addition, lower column tray 3′ of a further assembly kit arranged thereabove can be seen. Upper column tray 2 comprises a central downcomer 6 with two downcomer walls 7. Arranged in central downcomer 6 are cross struts 21 which connect the two downcomer walls 7 to each other. Attached to outer sides 15 of downcomer walls 7 are column internals mounting angles 16. Column internals mounting angles 16 are attached with first mounting points 17 to outer sides 15 of downcomer walls 7 of central downcomer 6 and thereby to upper column tray 2. It would also be possible to attach the column internals mounting angles to the inner sides of the downcomers. In addition, column internals mounting angles 16 comprise second mounting points 18 with which they are connected to second column tray 3. In the region of central downcomer 6, second column tray 3 has a depressed inlet zone 8, a so-called inlet cup, which is lowered in comparison to the remainder of the tray. This inlet cup does not need to be provided. Second column tray 3 comprises two lateral downcomers 10 each with one downcomer wall 11. As shown in FIG. 1 by way of second column tray 3′ of a further assembly kit shown above, column internals mounting angles 16 are also attached to the outer sides of downcomer walls 11′ of lateral downcomers 10′ and each connected by way of second mounting points 18 to upper column tray 2 of completely illustrated lower assembly kit 1 disposed therebeneath. It would also be possible to attach the column internals mounting angles to the inner sides of the downcomers. Reinforcement supports 36 protrude into lateral downcomers 10′ and form an extension of column internals mounting angles 16. Upper column tray 2 also comprises depressed inlet zones 8 in the region of lateral downcomers 10′.

FIG. 2 shows upper column tray 2 of assembly kit 1 from FIG. 1 in a perspective view. In addition, a downcomer wall 11′ of a lateral downcomer 10′ of the lower column tray of an assembly kit disposed thereabove is shown. In the region of second lateral downcomer 10′ of the lower column tray of the assembly kit disposed thereabove, only column internals mounting angles 16 and reinforcement supports 36 are shown. As already described, upper column tray 2 comprises depressed inlet zones 8 in the region of lateral downcomers 10′. Depressed inlet zones 8 are each assembled from two segments 8.1, 8.2. Mass transfer regions 37 of upper column tray 2 adjoin depressed inlet zones 8. Mass transfer regions 37 of upper column tray 2 are likewise assembled from individual segments. Mass transfer regions 37 of upper column tray 2 are configured as sieve trays and have gas passage openings 4 through which gas flowing from bottom to top through the column can flow. Both mass transfer regions 37 of upper column tray 2 lead to central downcomer 6. Central downcomer 6 is formed by the two downcomer walls 7 which are arranged spaced from each other. Disposed in central downcomer 6 are cross struts 21 which result in stabilization. At lateral ends 13 of central downcomer 6 or downcomer walls 7 of central downcomer 6, respectively, downcomer 6 or downcomer walls 7, respectively, can be connected to the column, for example, by welding or bolting. When installing downcomer walls 7 into the column, each downcomer wall 7 is leveled in the horizontal direction. Upper column tray 2 rests on downcomer walls 7 of central downcomer 6 and is therefore leveled also in the horizontal direction. In addition, upper column tray 2 is fixed by way of three column internals mounting angles 16 each to outer sides 15′ of downcomer walls 11′ of lateral downcomers 10′ of the lower column tray of an assembly kit disposed thereabove. For this purpose, column internals mounting angles 16 comprise at least one first mounting point 17 with which column internals mounting angles 16 are attached to downcomer wall 11′ of lateral downcomer 10′. In FIG. 2 the column internals mounting angles comprise three first mounting points 17. In addition, column internals mounting angles 16 comprise second mounting points 18 with which they are connected to upper column tray 2. At least one second mounting point 18 is provided. In the example shown in FIG. 2, the central column internals mounting angle 16 comprises three second mounting points 18, both outer column internals mounting angles 16 each comprise two second mounting points 18. The number of column internals mounting angles can vary and be adapted to the particular case of application. The column internals mounting angles shall be described later in detail with reference to FIG. 4.

In FIG. 3, lower column tray 3 and parts of central downcomer 6 of upper column tray 2 of assembly kit 1 from FIG. 1 are shown in a perspective view. For the sake of clarity, the rear downcomer wall of central downcomer 6 is not shown. In the region of central downcomer 6, lower column tray 3 has a depressed inlet zone 8, or an inlet cup, respectively, which is assembled from three segments 8.3, 8.4, 8.5. Mass transfer regions 39 of lower column tray 3 adjoin depressed inlet zone 8. These mass transfer regions 39 are likewise assembled from several segments and configured as sieve trays and comprise gas passage openings 4. The individual segments of depressed inlet zones 8 of lower column tray 3 and of upper column tray 2 as well as the individual segments of mass transfer regions 37 of upper column tray 2 and mass transfer regions 39 of lower column tray 3 are connected to each other in a known manner.

Bottom 9 of depressed inlet zones 8 of upper column tray 2 as well as lower column tray 3 is stepped downwardly in comparison to adjoining mass transfer regions 37 of upper column tray 2 and mass transfer regions 39 of lower column tray 3 and connected by way of lateral walls 38 to adjoining mass transfer regions 37 and 39, respectively.

As can be seen from FIGS. 2 and 3, each downcomer wall 7 of central downcomer 6 as well as each downcomer wall 11 of lateral downcomers 10 is angled in its longitudinal direction in the upper region, so that a resting support 12 is formed on which upper column tray 2 and lower column tray 3, respectively, rest and is attached to, for example with bolts.

Each downcomer wall 7 of central downcomer 6 is formed substantially rectangular. Along its short sides 13, which extend in the longitudinal direction of the column, each downcomer wall 7 comprises attachment options for the attachment to the column. In the case illustrated, attachment openings 14 are provided with which each downcomer wall 7 can be attached to the interior of the column wall. For example, it can be provided that longitudinal struts are welded to the interior of the column, to which downcomer walls 7 are bolted by way of attachment openings 14. Attached to outer sides 15 of downcomer walls 7 are column internals mounting angles 16. Column internals mounting angles 16 are attached to outer sides 15 of downcomer walls 7 with at least one first mounting point 17. FIG. 3 shows three first mounting points 17 for each column internals mounting angle 16. In addition, column internals mounting angles 16 each comprise at least one second mounting point 18, via which they are connected to lower column tray 3 or to the individual segments of mass transfer regions 39 of lower column tray 3, respectively. FIG. 3 shows two second mounting points 18 for each column internals mounting angle 16. In addition, a longitudinal strut 19 is attached to outer sides 15 of downcomer walls 7. Column internals mounting angles 16 have recesses 20 through which longitudinal strut 19 is passed. Cross struts 21 are attached in the interior of central downcomer 6. Cross struts 21 extend substantially at a right angle to the longitudinal extension of downcomer 6 and are connected to downcomer walls 7, for example bolted thereto. In the example illustrated, cross struts 21 are arranged on the inner sides of downcomer walls 7 at the position at which column internals mounting angles 16 are respectively mounted on outer side 15 of downcomer walls 7. As shown, lower column tray 3 is attached to each downcomer wall 7 with several column internals mounting angles 16, in the case illustrated, six column internals mounting angles 16. Depending on the case of application, more or fewer column internals mounting angles can be used.

Upper column tray 2 is connected in the same manner to downcomer walls 11 of lateral downcomers 10 of lower column tray 3 of a further assembly kit disposed thereabove. However, the lateral downcomers comprise no cross struts, but reinforcement supports 36 which are attached to the inner sides of downcomer walls 11 at the point where column internals mounting angle 16 are arranged at the outer side of downcomer walls 11.

The mode of operation of lower column tray 3 and upper column tray 2 arranged thereabove shall be briefly described below. During operation of the column, a gas flows from below through the column and assembly kits 1 mounted therein with lower column trays 3 and upper column trays 2. A liquid is introduced from above onto column trays 2, 3. On upper column tray 2, the liquid arrives at depressed inlet zones 8 through lateral downcomers 10. Once a liquid level that exceeds the height of lateral wall 38 of depressed inlet zones 8 has been reached, the liquid flows over mass transfer regions 37 of upper column tray 2. The gas flows through gas passage openings 4 and is exposed to the liquid. The liquid flows towards central downcomer 6 and is discharged via central downcomer 6 onto lower column tray 3 There, the liquid enters depressed inlet zone 8 until a certain level has been reached and then flows through mass transfer regions 39 of lower column tray 3. Gas flows through gas passage openings 4 through lower column tray 3 and is also exposed to the liquid. The liquid then flows outwardly to lateral downcomers 10 and there flows down onto upper column tray 2 arranged therebeneath of a further assembly kit 1.

This example describes dual-flow column trays. However, the column internals mounting angles can also be used for single-flow column trays in which each column tray comprises only one lateral downcomer.

The use of column internals mounting angles with multi-flow column trays, e.g. four-flow column trays, is likewise possible. The depressed inlet zone of the column trays can possibly be dispensed with.

FIG. 4 shows a column internals mounting angle 16 from assembly kit 1 of FIG. 1. Column internals mounting angle 16 can be used for attaching an upper column tray 2 to downcomer wall 11 of a lateral downcomer 10 as well as for attaching a lower column tray 3 to downcomer walls 7 of a central downcomer 6. Column internals mounting angle 16 comprises a body 22 with a back 23 and two legs 24. Back 23 is formed integrally with legs 24, where legs 24 are arranged at a right angle to back 23. Body 22 is preferably formed as a sheet metal bending member. Formed in back 23 of body 22 are first mounting points 17. In the embodiment illustrated, these are three long holes. Furthermore, recess 20 is formed in back 24. Recess 20 extends up into legs 24. In a lower region of legs 24, two bent horizontal supports 25 are disposed in legs 24. For this purpose, two L-shaped recesses 24 are provided in each of legs 24, into which the L-shaped bent horizontal supports 25 are inserted. The horizontal supports 25 can be fixedly connected to legs 24, for example, be welded thereonto. Both horizontal supports 25 are spaced apart from each other, so that a slot 26 is formed between them. A bolt 27 is arranged in this slot 26 adjacent to each leg 24. Bolts 27 are arranged outside of body 22. Horizontal supports 25 also extend on the outer side of legs 24 beyond a certain distance. Bolts 27 are attached in slot 26 with the aid of first nuts 28 and washers 29. By loosening nuts 28, bolts 27 can be moved to and fro in slot 26 between the two horizontal supports 25 and moved to a desired horizontal position. Nuts 28 are there tightened and bolts 27 are fixed at the desired horizontal position. Bolts 27 extend downwardly below horizontal supports 25 and there comprise at least two second nuts 30. In the installed state of column internals mounting angles 16, upper column tray 2 and lower column tray 3, respectively are arranged between second nuts 30. Second nuts 30 are then moved on bolts 27 until the respectively desired vertical position of upper column tray 2 or, respectively, lower column tray 3 is set at this position and the vertical distance between first mounting points 17 and second mounting points 18 is thus set and the column tray is thereby aligned in the horizontal direction. Bolts 27 with nuts 38, 30 arranged thereon form second mounting points 18. Two second mounting points 18 are thus provided. More or fewer second mounting points are also possible.

Column internals mounting angle 16 can be used for single-flow or multi-flow column trays. The recess in the back of the column internals mounting angle can also be dispensed with.

The mode of operation of column internals mounting angles 16 shall now be explained in more detail below with reference to FIGS. 5 and 6.

FIG. 5 shows a side view of an assembly kit 1 parallel to the downcomers in the state installed in the column. Downcomer walls 7 of central downcomer 6 are attached to longitudinal struts 31 fixedly connected to the column wall, for example bolted thereto. Upper column tray 2 rests on the upper side of downcomer walls 7. Column internals mounting angles 16 are attached on the outer sides of downcomer walls 7. FIG. 5 shows four column internals mounting angles 16. Each column internals mounting angle 16 has three horizontal long holes in its back that form first mounting points 17. Disposed in each long hole 31 is a bolt 32 which extends through a bore in downcomer wall 7. Before bolt 32 is tightened, column internals mounting angle 16 is moved to the desired horizontal position. Column internals mounting angle 16 is fixed in this position by tightening bolt 32. Both bolts 27 of a column internals mounting angle 16 together with second nuts 30 arranged thereon respectively form second mounting point 18 at which column internals mounting angle 16 is connected to lower column tray 3. For this purpose, bolts 27 are fitted in mounting holes in lower column tray 3, so that one of second nuts 30 is above lower column tray 3 and another of second nuts 30 is below lower column tray 3. Second nuts 30 are positioned on bolts 27 such that lower column tray 3 is moved to the desired position and thereby leveled in the horizontal direction. FIG. 5 shows how a lower column tray 3, which rests on a slanted support ring 41, can still be leveled in the horizontal direction using column internals mounting angles 16. The broken line shows the position of lower column tray 3 when no additional attachment is provided by column internals mounting angles 16. In this case, lower column tray 3 is significantly higher on the left-hand side than on the right-hand side, so that lower column tray 3 is arranged slanted over the column cross-section. In this case, no uniform liquid distribution would be possible across lower column tray 3. It is possible with the aid of column internals mounting angles 16 to pull lower column tray 3, at least a large central region, upwardly or push it downwardly, so that horizontal leveling of lower column tray 3 can be realized, at least in the central region. This is done in that lower column tray 3 is pulled upwardly at the respective position or pressed downwardly by suitably selecting the position of the two second nuts 30 on respective bolts 27. In FIG. 5, lower column tray 3 is indicated by a solid line after leveling. Uniform distribution of liquid is there again ensured.

FIG. 6 shows an example in which lower column tray 3 sags at the center of the column (broken line). This can be the case, for example, with columns having a large diameter. Here as well, no uniform distribution of liquid on lower column tray 3 would be guaranteed. Column internals mounting angles 16 can there also be used in order to level lower column tray 3 in the horizontal direction and to move it to the desired horizontal position. Lower column tray 3 is now pulled upwardly using bolts 27 and second nuts 30 arranged thereon. Only a smaller amount is necessary for this in the outer regions of lower column tray 3 which are located close to the column wall, at the center, lower column tray 3 must be pulled upwardly to a greater degree. Sagging of lower column tray 3 can therefore be prevented with column internals mounting angles 16. The position of lower column tray 3 after leveling is shown by the solid line. Upper column tray 2 rests on downcomer walls 7 of central downcomer 6. During installation, central downcomer 6 is aligned horizontally. Due to the attachment directly to the column inner wall, central downcomer 6 is very stable and can also carry upper column tray 2.

Nevertheless, an additional attachment of respective upper column tray 2 to lower column tray 3 of an assembly kit 1 arranged thereabove can also be provided, as shown in FIGS. 1-3. It can also be provided that the column internals mounting angles have no adjustment options. The column internals mounting angles are nevertheless advantageous because they stabilize the attachment of the column trays to the downcomers and thus make the use of cross members for reinforcement at the column trays superfluous.

As already described, it is also possible to attach the column internals mounting angles to the inner sides of the downcomer walls.

### LIST OF REFERENCE NUMERALS

1 assembly kit
2 upper column tray
3, 3′ lower column tray
4 gas passage opening
6 central downcomer
7 downcomer walls of the central downcomer
8 depressed inlet zone
8.1 first segment depressed inlet zone upper column tray
8.2 second segment depressed inlet zone upper column tray
8.3 first segment depressed inlet zone lower column tray
8.4 second segment depressed inlet zone lower column tray
8.5 third segment depressed inlet zone lower column tray
9 bottom of the depressed inlet zone
10, 10′ lateral downcomer
11, 11′ downcomer wall lateral downcomer
12 resting support
13 lateral ends downcomer wall
14 attachment opening
15 outer side downcomer wall
16 column internals mounting angle
17 first mounting point
18 second mounting point
19 longitudinal strut
20 recess
21 cross strut
22 body
23 back
24 leg
25 horizontal support
26 slot
27 bolts
28 first nut
29 washer
30 second nut
31 longitudinal strut
32 long hole
33 bolt
34 support ring
36 reinforcement supports
37 mass transfer region upper column tray
38 lateral wall depressed inlet zone
39 mass transfer region lower column tray

1. Assembly kit for installation of two column trays into a column with an upper column tray, the assembly kit comprising:
at least one downcomer shaft with at least one downcomer wall, and with a lower column tray arranged vertically spaced below said upper column tray and connected thereto; and
at least one column internals mounting angle, which includes at least one first mounting point, at least one second mounting point, and an adjustment means for adjusting a vertical distance between said at least one first mounting point and said at least one second mounting point, said adjustment means being attached with said at least one first mounting point to said downcomer wall and being connected with said at least one second mounting point to said lower column tray.

2. Assembly kit according to claim 1, wherein a vertical position of said at least one first mounting point or of said at least one second mounting point of said column internals mounting angle is defined, and at least one other mounting point of said column internals mounting angle is movable in the vertical direction.

3. Assembly kit according to claim 1, wherein said adjustment means of said column internals mounting angle comprises:
at least one first element on which at least one second element is arranged movable in the vertical direction, and said at least one second element can be secured at different vertical positions.

4. Assembly kit according to claim 1, wherein said adjustment means of said column internals mounting angle comprises:
at least one vertically arranged bolt on which at least two second nuts are arranged.

5. Assembly kit according to claim 1, wherein a horizontal position of said at least one first mounting point and/or said at least one second mounting point of said column internals mounting angle is adjustable.

6. Assembly kit according to claim 1, wherein said column internals mounting angle comprises:
several first and/or several second mounting points.

7. Assembly kit according to claim 1, wherein said column internals mounting angle comprises:
a back; and
at least one leg connected to said back, where said at least one first mounting point is formed in said back and said at least one second mounting point is formed on said leg.

8. Assembly kit according to claim 7, comprising:
a recess for receiving a longitudinal strut is formed in said back of said column internals mounting angle.

9. Assembly kit according to claim 7, wherein said at least one leg of said column internals mounting angle is connected to two horizontal supports that are arranged spaced from each other and form part of said at least one second mounting point.

10. Assembly kit according to claim 1, wherein said lower column tray is attached to said downcomer wall by way of a plurality of column internals mounting angles.

11. Assembly kit according to claim 1, wherein said at least one downcomer is arranged centrally in said upper column tray and comprises:
two downcomer walls, wherein at least one column internals mounting angle is respectively arranged on each downcomer wall and connects said lower column tray to said at least one downcomer.

12. Assembly kit according to claim 1, comprising:
at least one cross strut is arranged in an interior of said at least one downcomer, said at least one column internals mounting angle being attached as an extension of said at least one cross strut to an outer side of said at least one downcomer wall.

13. Assembly kit according to claim 1, wherein said column trays form a depressed inlet zone below said downcomer.

14. Assembly kit according to claim 1, wherein said at least one downcomer comprises:
mounting points at its ends facing the column for the attachment to said column.

15. A column internals mounting angle, comprising:
at least one first mounting point for attachment to an upper column tray;
at least one second mounting point for attachment to a lower column tray; and
an adjustment means for adjusting a vertical distance between said at least one first mounting point and said at least one second mounting point the column internals mounting angle being configured for an assembly kit.

16. A mass transfer column comprising:
a column interior: and
at least one assembly kit according to claim 1 attached in the column interior.

17. Assembly kit according to claim 2, wherein said adjustment means of said column internals mounting angle comprises:
at least one first element on which at least one second element is arranged movable in the vertical direction, and said at least one second element can be secured at different vertical positions.

18. Assembly kit according to claim 17, wherein said adjustment means of said column internals mounting angle comprises:
at least one vertically arranged bolt on which at least two second nuts are arranged.

19. Assembly kit according to claim 18, wherein a horizontal position of said at least one first mounting point and/or said at least one second mounting point of said column internals mounting angle is adjustable.

20. Assembly kit according to claim 19, wherein said column internals mounting angle comprises:
several first and/or several second mounting points.
